(19) United States
(12) Patent Application Publication
(10) Pub. No.: US 2009/0150653 A1
(43) Pub. Date: Jun. 11, 2009

(54) Mechanism for soft error detection and recovery in issue queues

(76) Inventors: Pedro Chaparro Monferrer, Barcelona (ES); Xavier Vera, Bercelona (ES); Jaume Abella, Barcelona (ES); Javier Carretero Casado, Barcelona (ES)

Correspondence Address: TROP, PRUNER & HU, P.C., 1616 S. VOSS RD., SUITE 750, HOUSTON, TX, 77057-2631, US

(21) Appl. No.: 11/999,787

(22) Filed: Dec. 7, 2007

(51) Int. Cl. G06F 9/22

(52) U.S. Cl. 712/217; 712/E09.005

(57) ABSTRACT

In one embodiment, the present invention includes logic to detect a soft error occurring in certain stages of a core and recover from such error if detected. One embodiment may include logic to determine if a lapsed time from a last instruction to issue from an issue stage of a pipeline exceeds a threshold and if so to reset a dispatch table, as well as to determine if a parity error is detected in an entry of the dispatch table associated with an enqueued instruction and if so to prevent the enqueued instruction from issuance. Other embodiments are described and claimed.

### BACKGROUND

With future generations of semiconductor manufacturing technology, soft errors will become more frequent in semiconductor devices such as processors, chipsets and so forth. As a result, customers may experience frequent program crashes and data corruption unless detection and correction mechanisms are implemented.

This is so, as particle hits on the components of a processor are expected to create an increasing number of transient or soft errors in each new microprocessor generation. However, the limitations on complexity and power in current designs are driving the evolution of microarchitectures towards simpler cores. In that scenario, a chip microprocessor (CMP) with many simple in-order cores may be designed. Therefore, the failures in time (FIT), which is the expected number of failures in 10⁹ hours, target per-core reduces drastically (i.e., in a chip with a 400 FIT budget and 25 cores, each core cannot exceed 16 FIT). To comply with such constraints, FIT reductions are needed. Assuming that large memory structures like caches and register files are protected against such errors (however, these protection mechanisms require large expenses in area and power), the issue queue remains as a large contributor of the core's FITs.

### BRIEF DESCRIPTION OF THE DRAWINGS

FIG. 1 is a pipeline of an in-order processor in accordance with one embodiment of the present invention.

FIG. 2 is a flow diagram of a method in accordance with an embodiment of the present invention.

FIG. 3 is a flow diagram of a method for issue queue protection in accordance with an embodiment of the present invention.

FIG. 4 is a block diagram of a system in accordance with an embodiment of the present invention.

FIG. 5 is a schematic diagram of a pipeline in accordance with one embodiment of the present invention.

### DETAILED DESCRIPTION

In various embodiments, a scheme to detect and recover from soft errors in the micro-operation (micro-op) issue system of an in-order core may be provided. The detection of errors is achieved by computing the parity of the information, and can be applied both to an issue queue and to a scoreboard. To recover a consistent state when a parity error is detected in the issue queue, a mechanism to track the program counter (PC) of an instruction triggering an exception is used. For the scoreboard, a reset mechanism may be sufficient to recover from an inconsistency.

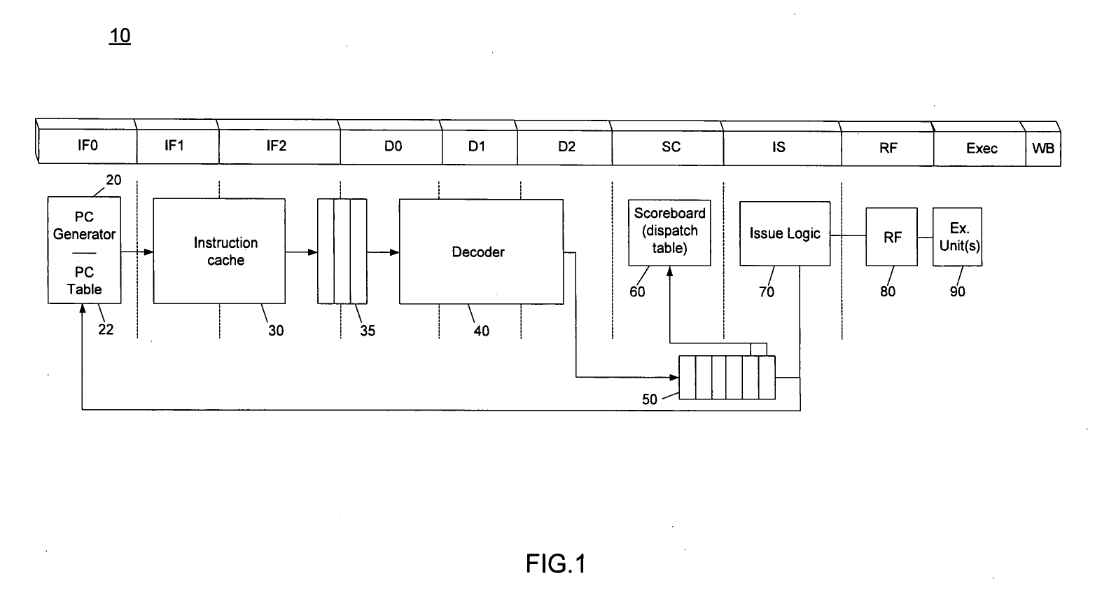

FIG. 1 shows the pipeline of an in-order processor through various stages. As shown in FIG. 1, processor 10 includes various stages including instruction fetch stages (IF0-IF2), instruction decode stages (D0-D2), a scoreboard stage (SC), an instruction issue stage (IS), a register file (RF) stage, an execution stage, and a writeback stage. While shown with these relatively high level stages in the embodiment of FIG. 1, understand that different implementations may include more or fewer such stages.

Certain structures within processor 10 are also shown in FIG. 1. Specifically, processor 10 includes a program counter (PC) generator 20 which may further include a PC table 22 that stores the generated program counters. Each entry in PC table 22 is identified with a number (PCId). PC generator 20 is coupled to an instruction cache 30 that in turn is coupled to a plurality of prefetch buffers 35, which in turn are coupled to a decoder 40.

Referring still to FIG. 1, in turn decoder 40 is coupled to an issue queue 50 which in turn is coupled to a dispatch table such as a scoreboard 60, as will be described further below. Instructions ready for issuance, as determined by issue logic 70 may be provided to a register file 80 to obtain their operands for execution in one or more execution units 90. From there, results of executed instructions may be written to a destination storage such as register file 80 or a memory subsystem of the processor such as various memory order buffers and cache memories.

In operation, PC generator 20 sends addresses to instruction cache 30. The instruction cache 30 fills prefetch buffers 35 that decouple the fetch engine of decoder 40. In various embodiments, the full fetch process takes 3 cycles (stages IF0-IF2). The decoder 40 is fed by prefetch buffers 35 and generates micro-ops (in 3 stages) that are inserted into issue queue 50. After that, in scoreboard (SC) 60 stage, the first two instructions in the queue in single-thread mode (in simultaneous multithreading (SMT) mode, the two oldest instructions of each thread) check the scoreboard table to decide whether their operands are ready or not. If so, the micro-ops proceed to be issued for execution by sending them to execution units 90. While shown with this particular implementation and the limited components in FIG. 1, understand that the scope of the present invention is not limited in this regard.

In various embodiments, issue logic 70 may include one or more logic blocks to perform error detection and correction in accordance with an embodiment of the present invention. More specifically, issue logic 70 may include a watchdog timer to detect a deadlock situation in which a soft error to an entry in the scoreboard prevents issuance of an instruction.

In one embodiment, a scoreboard includes a table with as many rows as logical registers and as many columns as the maximum execution latency. A logic 1 in position n of row r indicates that register r will be available in the register file in n cycles from a current cycle. A logic 1 in the column 0 indicates that the register is available in the register file. A logic 1 in column n>0 indicates that the value is available in the proper bypass (if that bypass exists) or that the operand is not yet available.

When an instruction issues, it updates the row corresponding to its destination register. It writes a logic 1 in the column of the cycle when the micro-op will write the result in the register file. The rest of columns are reset to a logic zero value. Every cycle, the columns are left-shifted so that the progress of the micro-ops through the pipeline is mimicked in the scoreboard table. When a 1 reaches the left-most column that particular row stops shifting. This way, the current “status” of the micro-op generating each one of the registers is always known. By checking the table, a dependent instruction knows when to issue and from where to obtain an operand.

A soft error in an entry in the scoreboard can derive from the following situations. First, a cell containing a 1 is flipped to 0. Then, a dependent instruction will never see its operand as available. Second, a cell containing a 0 is flipped to 1. This can derive into two scenarios: (1) that cell is on the left of the column containing the correct 1, which will cause a dependent instruction to issue before the operand is available; and (2) that cell is on the right of the column containing the correct 1, which will cause no problem as long as the logic that processes the information from the scoreboard checks for a 1 from left to right.

In the first case the processor will deadlock. To recover from this situation, a watchdog timer may be implemented in the issue stage to detect the problem. If the time elapsed from the last instruction issue is greater than the maximum instruction latency (which may be a hard-coded value) then the scoreboard has been corrupted. Since in such case there is no in-flight instruction, the scoreboard can be safely reset (that is, setting in all entries a 1 in the first column and a 0 in the rest). Once done, the execution can proceed normally.

For the second case a parity check is done after an instruction issues. Note that, by definition, each entry in the table must have parity of 1. The parity check can be done once the information from the scoreboard is read, in parallel with the issue logic decisions (thus, does not impact the cycle time). Alternatively, the checking can be done in the following stage. If the parity is incorrect, then there is a chance that the micro-op has been issued prematurely. In that case, the issue process is stopped and the faulting instruction is prevented from flowing out of the issue queue. To resume correct execution, the pipeline—after the issue stage—is allowed to drain. Once done, all values are available in the register file. This means that the scoreboard can be safely reset (as described before). From that point, the execution can resume normally. This can be easily achieved by employing the same watchdog timer used in the first case.

The overhead of this mechanism is very small: (1) a watchdog timer; and (2) parity checkers for the scoreboard information each issued micro-op uses. Note that there is no need to store any protection information in the scoreboard itself. Of course other techniques to protect the logic and the scoreboard may also be used.

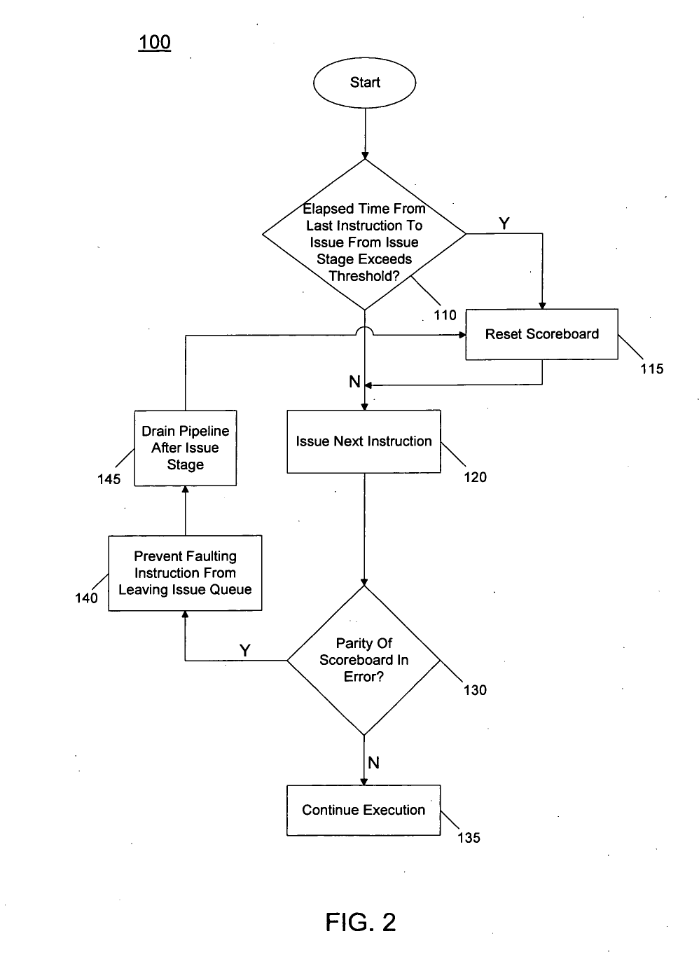

Referring now to FIG. 2, shown is a flow diagram of a method in accordance with an embodiment of the present invention. As shown in FIG. 2, method 100 may be used to provide protection for an issue queue in accordance with an embodiment of the present invention. Method 100 may begin by determining whether an elapsed time from a last instruction issued from the issue stage is greater than a threshold (diamond 110). For example, reference may be made to a value of a watchdog or other timeout timer, which may be set to a predetermined value corresponding to a maximum instruction latency. If the elapsed time has been exceeded, control passes to block 115 where the scoreboard may be reset. More specifically, an oldest column of the scoreboard may be set to one and all other columns set to zero. Control passes to block 120, where the next instruction may issue.

Referring still to FIG. 2, at instruction issuance or in the following instruction, it may be determined whether the parity associated with the issued instruction is correct (diamond 130). If no parity error occurs, normal execution may continue at block 135. If instead an error is detected, control passes to block 140 where the faulting instruction may be prevented from leaving the issue queue. Furthermore, the processor pipeline following the issue stage (i.e., RF stage, execution stage and so forth) may be allowed to drain (block 145), after which the scoreboard may be reset, as described above (block 115). Control then passes back to block 120 for further normal operation of the processor pipeline. While shown with this particular implementation in the embodiment of FIG. 2, the scope of the present invention is not limited in this regard.

In order to detect faults in the issue queue, its information is protected by means of either ECC or parity codes. This gives two different protection possibilities at different costs. When ECC is used to protect all information stored in the issue queue, if an error is detected, the correction code recovers the original information. The coverage is 100% and the recovery capability is also 100% (assuming single bit upsets and implementing ECC). However, extra power consumption may be realized.

Thus other embodiments may rely on parity with recovery. More specifically, an exception recovery mechanism to recover the PC of any instruction in the issue queue may be used. In particular, it may be assumed that a program counter identifier (PCId) flows along with any micro-op through the pipeline until it is checked for exceptions. The PCId is the identifier of a table located in the front end that stores PCs. Such recovery information is available at the issue stage.

When an instruction issues, the parity of the issue queue entry is checked. If a parity error is detected, the faulting micro-op recovers its PC (as if it was recovering from an exception) by sending a signal to the front end unit using the PCId. The fetch resumes from the PC grabbed from the PC table and all stages from fetch to issue are flushed.

To guarantee correct recovery, the recovery information (i.e., the PCId) is also protected with parity separately. An error in such information implies that the recovery is not possible. The whole fault detection mechanism works as follows. When a micro-op issues, the issue queue information is checked for a parity error; if correct it proceeds to issue. The check can be done either in the same issue stage or doing a late-check in the following cycle. If incorrect, the pipeline is stalled and the recovery information is checked for a parity error. If correct, the recovery information is sent to the fetch stage, all stages from fetch to issue are flushed, and the execution proceeds normally. If there is instead an error, a detected unrecoverable error (DUE) error is signaled to the user.

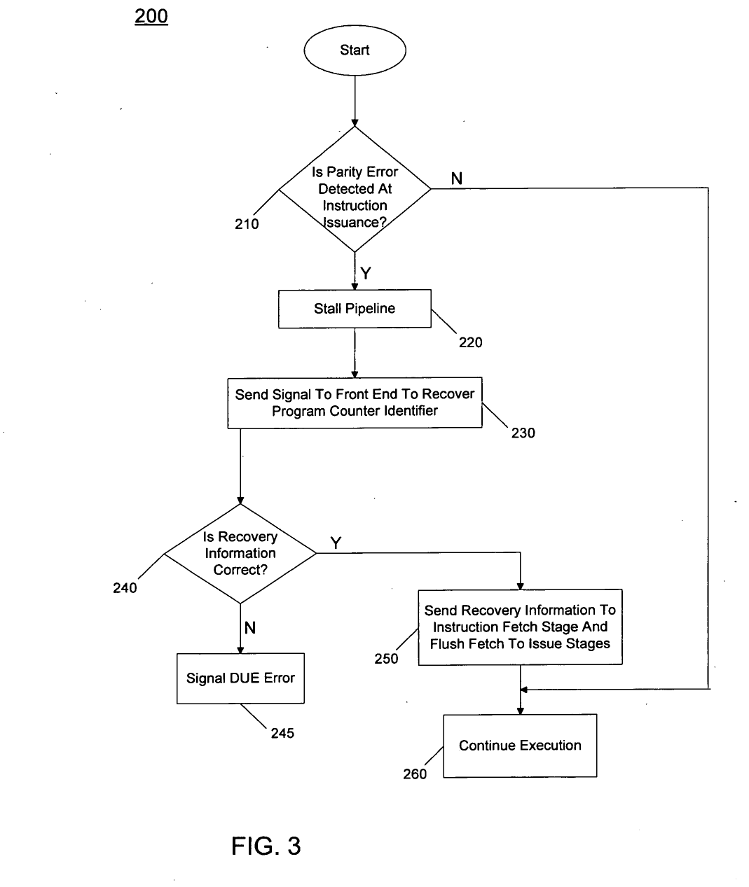

Referring now to FIG. 3, shown is a flow diagram of a method for issue queue protection in accordance with an embodiment of the present invention. As shown in FIG. 3, method 200 may begin by determining whether a parity error is detected at instruction issuance (diamond 210). More particularly, at instruction issuance the instruction queue entry associated with the instruction may be parity checked to determine whether the error exists. If not, normal processor pipeline execution may continue (block 260).

If however, a parity error is detected, control passes to block 220, where the pipeline may be stalled. Either concurrently with, before or after the pipeline stalling, a signal may be sent to a front end unit to recover the PC associated to a PCId (block 230). More specifically, as described above a signal from issue logic 70 or issue queue 60 may be sent back to PC generator 20, and more particularly to table 22 to recover the PC associated to the PCId. As this value is separately parity protected, it may then be determined whether this recovery information is correct (diamond 240). If not, a DUE error may be signaled (block 245). Otherwise, the recovery information may be sent to the instruction fetch stage and stages from instruction fetch to instruction issuance may be flushed (block 250). Then the correct instruction may be fetched and normal pipeline execution may continue (block 260). While shown with this particular implementation in the embodiment of FIG. 3, the scope of the present invention is not limited in this regard.

This mechanism provides 100% error detection coverage and, practically 100% recovery capabilities, as the only case in which it is not possible to recover is in the unlikely chance of having errors in both the recovery information and in the issue queue information. Further, power consumption for the protection is minimal, and is less than approximately 5%.

Embodiments also valid for out-of-order processors. In that case, the recovery information is stored in the reorder buffer. When an instruction issues, it checks the parity of the issue queue entry. If a parity error is detected, the instruction flows marked as if it had produced an exception. When it retires (i.e., when it is checked as to whether the instruction caused an exception or not) the micro-op resets the fetch mechanism by sending to the front end its PCId and the pipeline is flushed.

Additionally, in an in-order processor, in case an error is detected both in the issue and in the recovery information, it might be possible to recover from an older instruction in the pipeline. This depends on the particular details of the microarchitecture. Conceptually, if such situation arises, the previous micro-op in the pipeline is provided as a valid recovery point. If its recovery information has not been corrupted, the pipeline may recover from that information as long as that particular micro-op and any younger micro-ops are squashed. For instance, re-executing by starting at the current micro-op checking for exceptions would be possible. In addition, other techniques may also be applicable to protect the read/write logic of the queue.

Embodiments are thus able to protect the issue queue, one of the structures with a high FIT rate in an in-order core. Such techniques are able not only to detect but to recover from faults. It does so at a smaller cost than classical ECC correction. By lowering the FIT rate by implementing a technique with lower power requirements than ECC, a higher number of cores can be integrated under the same FIT and power budgets.

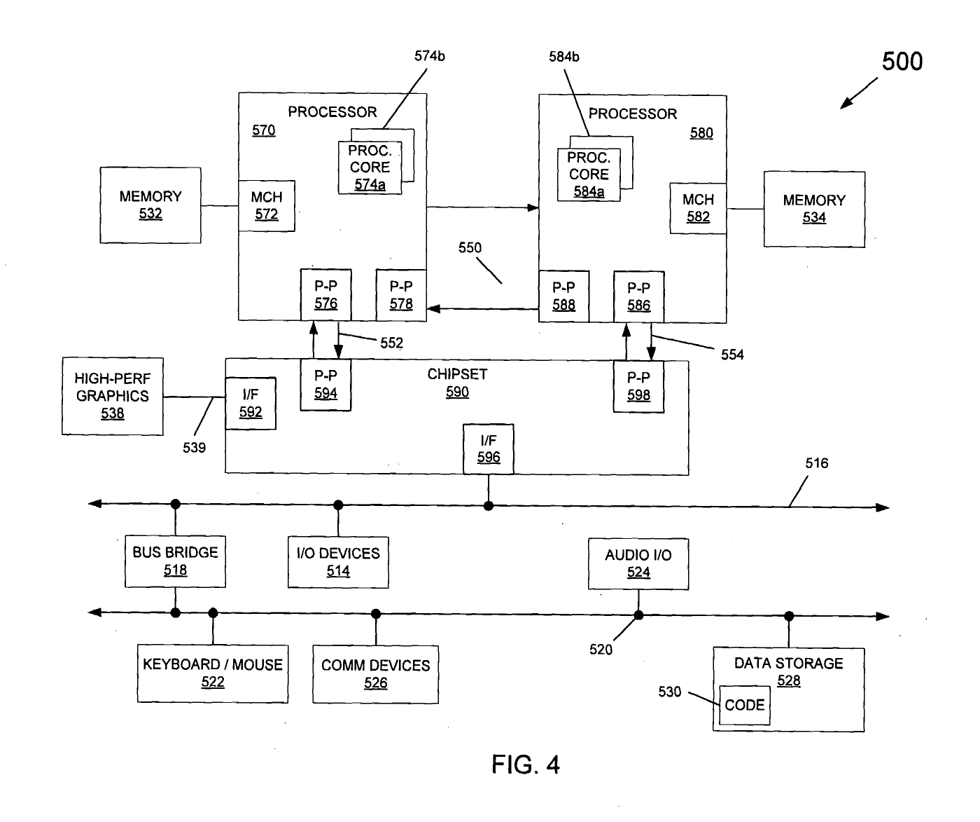

Embodiments may be implemented in many different system types. Referring now to FIG. 4, shown is a block diagram of a system in accordance with an embodiment of the present invention. As shown in FIG. 4, multiprocessor system 500 is a point-to-point interconnect system, and includes a first processor 570 and a second processor 580 coupled via a point-to-point interconnect 550. As shown in FIG. 4, each of processors 570 and 580 may be multicore processors, including first and second processor cores (i.e., processor cores 574a and 574b and processor cores 584a and 584b). Each processor core may include hardware, software, firmware or combinations thereof to enable protection of issue queue and scoreboards in accordance with an embodiment of the present invention.

Still referring to FIG. 4, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 4, MCH's 572 and 582 couple the processors to respective memories, namely a memory 532 and a memory 534, which may be portions of main memory (e.g., a dynamic random access memory (DRAM)) locally attached to the respective processors. First processor 570 and second processor 580 may be coupled to a chipset 590 via P-P interconnects 552 and 554, respectively. As shown in FIG. 4, chipset 590 includes P-P interfaces 594 and 598.

Furthermore, chipset 590 includes an interface 592 to couple chipset 590 with a high performance graphics engine 538 via a P-P interconnect 539. In turn, chipset 590 may be coupled to a first bus 516 via an interface 596. As shown in FIG. 4, various I/O devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

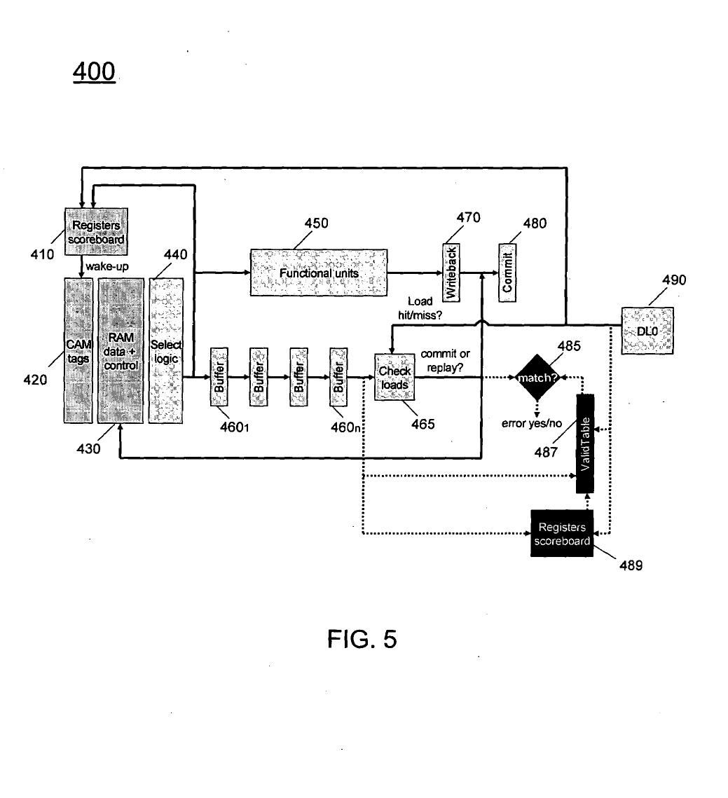

As described above, embodiments may also be used in out-of-order cores. The issue logic in out-of-order cores includes four main components (see the four leftmost blocks in FIG. 5): CAM logic 420 to wake-up instructions, RAM logic 430 to store data and control signals of instructions, selection logic 440 to choose the proper instructions to issue, and the scoreboard 410 to track when each register becomes available. CAM, selection and scoreboard may observe soft and hard errors, which may end up awaking or selecting unready instructions, or delaying indefinitely ready instructions. Sources of failure causing wrong operation are as follows: (1) shorts or opens may appear in bitlines propagating tags for wake-up, as well as in matchlines activating ready bits. Similarly, soft errors and defects in silicon or wordlines may make some of the tag bits to be wrong, in such a way that wake-up may happen prematurely or not happen at any time because the tag has changed; (2) soft and hard errors in selection logic may make an unready instruction to be selected for issuing, or a ready instruction to remain indefinitely in the issue queue; and (3) scoreboard logic tracks the tags to be propagated to the CAM logic 420 to wake up operands as soon as possible, ensuring that data will be available at issue time. Premature tag propagation or no tag propagation at all leads to errors similar to those of the CAM logic 420.

Mechanisms to cover for these errors may be provided. Solutions for the different types of errors are as follows. A table (ValidTable 487) is set up to track which operands are ready. For the sake of clarity, assume that instructions dependent on unresolved loads may be issued prematurely. That could happen if instructions are issued assuming that loads will hit in cache, but such loads miss. Whenever an instruction is issued and any load it might depend on has been resolved (i.e., hit/miss information is known for such loads) the instruction validates whether its input operands are either available or unavailable due to a previous load that missed in DL0 490. To do so, the instruction checks both the logic in place for such purpose (check loads 465 in FIG. 5) and ValidTable 487. If they provide different outcomes, an error is detected. In order to update ValidTable 487, instructions selected to issue update a replica of scoreboard logic (scoreboard 489). Note that single-cycle instructions also set the proper entry of ValidTable 487 (the one corresponding to their destination register if any). Scoreboard 410 tracks delayed wake-up of multi-cycle instructions. A watchdog timer is set for the oldest instruction in the reorder buffer (ROB) to detect errors in the issue system that prevents the oldest instruction to wake up. Once a soft or hard error is detected, recovery may be performed because errors in the issue system affect only speculative state, and hence, by flushing in-flight instructions normal operation can be recovered.

For the sake of illustration, FIG. 5 shows the schematic of a pipeline in accordance with one embodiment of the present invention. Assume that RAM block 430 of the issue queue is protected (e.g., parity or ECC protected). The pipeline works as follows. Instructions are issued from the issue queue (CAM+RAM+Select logic) and update scoreboard 410. Instructions proceed to the functional units for execution and whenever they finish their results are written back. In parallel with execution, instructions proceed to the checker where they validate whether they depend directly or indirectly on a load that missed but was unresolved for the time they were issued. If they did not depend on such a load, they are allowed to be marked as completed in the ROB. Otherwise, they are forced to replay from the issue queue whenever their inputs are available. All input operands matching the affected registers are marked as unready in the issue queue (RAM logic 430) and their entries are updated in the scoreboard.

Embodiments add steps that are performed in parallel to avoid any impact on the speed-paths of the pipeline. The steps are as follows. The replicated scoreboard 489 is updated like the original one. Whenever a register becomes ready, its corresponding entry in ValidTable 487 is updated. Further details about such table are provided later. Updates in the logic tracking load misses (check loads box) are performed also in ValidTable 487 to track which registers are actually available. Whenever an instruction checks whether it depends or not on a load that missed in DL0 490, it checks whether the output of the checker and the output of ValidTable 487 match. Note that checking only for parity is not enough to detect all errors in an out-of-order issue system because check loads may indicate that any register depends on different number of outstanding loads. Thus, ValidTable 487 tracks such information, which avoids the need for parity. If they match, no error is present. Otherwise, an error has been detected. There are two different sources for such an error: (i) the instruction was issued too early but the reason was not a load missing in DL0 490; or (ii) the instruction was issued properly but the checker detected an error that did not exist (the checker did not work properly due to a defect, a soft error, etc.). After an instruction reaches the head of the ROB, it is checked periodically to find out whether it has been issued or not. If after a given period of time it has not issued, an error has been detected. The only source for such errors corresponds to instructions whose operands are ready but either they were not woken up or the instruction is never selected.

Detection of misspeculated instructions due to direct or indirect dependence on a load that misses DL0 490 is tracked with a bitvector with as many entries as potential unresolved in-flight loads the operand can depend on. For any load that the operand depends on, the corresponding bit is set. When any load is resolved as a miss, any operand depending on such load is set to unready in the registers scoreboard and in the RAM array of the issue queue. In-flight instructions check this condition when they reach the check loads stage.

ValidTable 487 tracks which registers are ready and its implementation depends on the microarchitecture. If a microarchitecture is used where there is a single register file for committed and speculative values, each entry has both a bit indicating whether the operand is ready and a bitvector that tracks dependences on unresolved loads. The operation of ValidTable 487 is as follows. Whenever a register is deallocated due to the commit or flush of an instruction, its ready bit in ValidTable 487 is reset. Whenever a result is produced, the proper ready bit in the table is set. Whenever a load is resolved as a miss, it resets the proper ready bits of ValidTable 487 (those whose entry has a bit set indicating that they depend on that load). Whenever an instruction reaches the check load stage, all previous loads have been resolved. The instruction checks in ValidTable 487 whether their input operands are effectively ready.

A different microarchitecture may exist where speculative values are stored in the ROB, whereas committed values are stored in a separate register file. ValidTable 487 has as many entries as the ROB. In that case, it may happen that an instruction A depends on another instruction B that occupies a given entry of the ROB (e.g., entry X). Whenever A checks whether B finished its execution, different situations may arise.

One, if B did not finish (ValidTable ready bit set to unready). A obtains consistent information from ValidTable 487. Or, B finished and did not commit (ready bit set to ready). A obtains consistent information from ValidTable 487. Or, B finished and committed but entry X was not allocated to a new instruction (ValidTable 487 bit set to ready). A obtains consistent information from ValidTable 487. Or, B finished and committed and entry X was allocated to a new instruction (ready bit set to the state of the new instruction). A checks whether B finished and even if B finished, the proper entry of ValidTable 487 indicates that such register is not ready because the entry was allocated to another instruction. To solve this issue, each entry in ValidTable 487 is extended with an extra bit (gender bit). All instructions in the ROB receive the same gender bit (e.g., “0”) until the tail wraps up. Then, the opposite gender bit (e.g., “1”) is given to all new instructions until the tail wraps up again. Such bit is stored in ValidTable 487 and in the rename table for each register in such a way that whenever an input operand is renamed, it obtains the gender bit of its producer. When checking for readiness in ValidTable 487, several situations may arise.

If the gender bit matches, the ready bit reports the right information about the readiness of the input operand. If the gender bit has changed, means that the producer finished and committed, and hence, the consumer does not care about the ready bit because the operand is available.

The overhead for embodiments in terms of power is 4.8% and in terms of area is 13.4% for the issue system (most of the extra area comes from the extra scoreboard). Cycle time should not be impacted because the extra hardware is not in the critical path. As shown, embodiments thus raise the coverage to full coverage for soft and hard errors at low cost.

Once an error is detected it can be identified whether it was a soft or a hard error. In case of having a hard error, the minimum associated amount of hardware (e.g., a single issue queue entry) may be disabled in such a way that the performance impact is minimal. To do so few small tables can track errors at different levels. For instance, for the out-of-order issue system errors are tracked at issue queue, wake-up port and entry level. The different structures for the out-of-order issue system are described in Table 1. Any number of bits can be used to count errors (K in the table), although a few bits are enough (e.g., K=4 bits).

TABLE 1

| Error | | | |
|---|---|---|---|
| location | Fields of the table | Size | When it is updated |
| Issue | #errors (K + 2 bits) | 1 | Check load and ValidTable |
| queue | | | report different outputs |
| | | | for the same instruction |
| Issue | Entry, #errors (K | 4 | Check load and ValidTable |
| queue | bits) | | report different outputs for the |
| entry | | | same instruction |
| Wake- | Port, #errors (K bits) | 4 | Check load and ValidTable |
| up port | | | report different outputs |
| | | | for the same instruction |

Since keeping track of errors in all blocks would require large storage and errors are expected to happen seldom, tables for error tracking can be small (e.g., 4 entries each) with least recently used (LRU) replacement. Whenever an error is detected, all tables are updated either inserting the new information of the faulty instruction or incrementing the proper error counter if the entry exists. From time to time (e.g., every 1 billion cycles) error counters are either shifted right or reset to get rid of faults tracked due to soft errors. Soft errors are relatively infrequent so even if some errors are reported due to strikes neither they will be enough to saturate any counter nor they will happen always in the same block. Thus, soft errors will not be enough to cause the deactivation of any operating block. On the other hand, hard errors may show up quite often during a period. Hence, the corresponding counters will saturate and faulty blocks will be deactivated. Note that the size of the counters may meet some constraints to ensure that fine-grain errors are not considered coarse-grain errors (issue queue error counter uses more bits than any other counter). For instance, many errors in a given issue queue entry will saturate the counter for such entry, but will not be enough to saturate the corresponding counter for the whole issue queue, which needs more errors to saturate. The issue queue entry number can be either propagated with instructions or tracked in a table (a separate table, the ROB itself, etc.). Similarly, the wake-up port used can be obtained from the replicated scoreboard, which will notify readiness of operands through the same ports as the original scoreboard. Note that errors in the selection logic, load checking logic, etc. that may affect instructions disregard of the issue queue entry or the wake-up port used, will be tracked as global issue queue errors.

Once a block is considered to be faulty it will be disabled (unless it is the whole issue queue), which can be done using hardware fuses to permanently invalidate the block or any other mechanism. In fact, redundant hardware not used at shipment may be available and can be used to replace the faulty block. Although error confinement is described for the out-of-order issue system, its implementation for the in-order issue system is analogous.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
first logic to determine if a lapsed time from a last instruction to issue from an issue stage of a pipeline exceeds a threshold and if so to reset a dispatch table coupled to the issue stage, wherein the dispatch table reset is to enable a deadlocked instruction in an instruction queue to issue from the issue stage;
second logic to determine if a parity error is detected in an entry of the dispatch table associated with an enqueued instruction and if so to prevent the enqueued instruction from issuance from the instruction queue.

2. The apparatus of claim 1, wherein the first logic is to reset the dispatch table by setting a first column of a plurality of entries of the dispatch table to a first value and setting all remaining columns of the entries to a second value.

3. The apparatus of claim 1, wherein the second logic is to drain pipeline stages following the issue stage of instructions after preventing the enqueued instruction from issuance.

4. The apparatus of claim 3, wherein the second logic is to reset the dispatch table after the pipeline stages are drained.

5. The apparatus of claim 1, further comprising third logic to determine if a parity error is detected in an entry of the instruction queue associated with an issued instruction and if so, to send a signal to a front end unit of the pipeline to obtain recovery information associated with the issued instruction.

6. The apparatus of claim 5, wherein the front end unit is to determine whether the recovery information is correct and if not, to signal a detected unrecoverable error (DUE).

7. The apparatus of claim 6, wherein the front end unit is to forward the recovery information to an instruction fetch stage of the pipeline if the recovery information is determined to be correct, to fetch an instruction associated with the recovery information, and wherein the pipeline is to be flushed between the instruction fetch stage and the issue stage.

8. A system comprising:
a processor including a front end unit to store a table of instruction identifiers, an issue stage coupled to the front end unit including an instruction queue and a scoreboard, wherein the processor is to determine if a lapsed time from a last instruction to issue from the issue stage exceeds a threshold and if so to reset the scoreboard, wherein the scoreboard reset is to enable a deadlocked instruction in the instruction queue to issue, and determine if a parity error is detected in an entry of the scoreboard associated with an enqueued instruction and if so to prevent the enqueued instruction from issuance from the instruction queue; and
a dynamic random access memory (DRAM) coupled to the processor.

9. The system of claim 8, wherein the processor comprises a many-core processor including a plurality of in-order cores.

10. The system of claim 8, wherein the processor is to reset the scoreboard by setting a first column of a plurality of entries of the scoreboard to a first value and setting all remaining columns of the entries to a second value.

11. The system of claim 10, wherein the processor is to drain pipeline stages following the issue stage of instructions after preventing the enqueued instruction from issuance and reset the scoreboard after the pipeline stages are drained.

12. The system of claim 11, wherein the processor is to determine if a parity error is detected in an entry of the instruction queue associated with an issued instruction and if so, to send a signal to the front end unit to obtain recovery information associated with the issued instruction.

13. The system of claim 12, wherein the processor is to determine whether the recovery information is correct and if not, to signal a detected unrecoverable error (DUE).

14. The system of claim 12, wherein the processor is to forward the recovery information to an instruction fetch stage if the recovery information is determined to be correct, to fetch an instruction associated with the recovery information, and wherein the processor is to be flushed between the instruction fetch stage and the issue stage.
